(19) United States
(12) Patent Application Publication
(10) Pub. No.: US 2022/0072628 A1
(43) Pub. Date: Mar. 10, 2022

(54) GAPLESS CHIPBREAKER

(71) Applicant: KYOCERA SGS PRECISION TOOLS, INC., Munroe Falls, OH (US)

(72) Inventors: Douglas P. BONFIGLIO, Akron, OH (US); Paul S. DANIELS, Munroe Falls, OH (US)

(21) Appl. No.: 17/309,861

(22) PCT Filed: Dec. 26, 2019
(86) PCT No.: PCT/US2019/068577

§ 371 Date: Jun. 24, 2021

Related U.S. Application Data
(60) Provisional application No. 62/785,795, filed on Dec. 28, 2018.

(51) Int. Cl. B23B 47/34; B23C 5/10

(52) U.S. Cl. CPC B23B 47/34; B23C 5/10

(57) ABSTRACT

Chip breaking features may be arranged in radial reliefs of a rotary cutting tool. The chip breaking features create gaps or voids in the otherwise continuous cutting edge, resulting in otherwise continuous chips being cut into discrete chips. The chip breaking features may be angled so as to define a secondary cutting edge. Depending on the angle at which the chip breaking features are angled, the secondary cutting edges may partially or completely close the gaps or voids in the cutting edge. Closing the gaps or voids in the cutting edge ensures that each blade removes nearly all material so the following blade does not have to clean up.

### CROSS-REFERENCE TO RELATED APPLICATIONS

This application claims priority to and the benefit of pending U.S. Provisional Application No. 62/785,795 filed Dec. 28, 2018, which is incorporated by reference herein in its entirety.

### BACKGROUND

When removing material from a work piece, breaking the material into discrete chips improves the ability of the removed material to flow more easily out of the work piece area, and also reduces heat generation and the pressure exerted on the end mill. Rotary cutting tools, such as end mills, sometimes include chip breaker features that help break otherwise continuous chips of material into discrete chips of material. These cutting tools, also known as “chip breaker tools” or “chip breakers,” have been developed to facilitate chip removal by creating discrete chips, and include chip breaking features or notches that are cut transversely into the cutting blades at spaced intervals. As compared to a conventional cutting tool with cutting edges that do not include such chip breaking features or notches, the cutting edges of chip breakers are provided as interrupted cutting edges.

The chip breaker features may be provided in various configurations. Chip breaker tools configured for roughening operations may be provided with wavy notch patterns, also known as sinusoidal chip breakers, and such tools produce a rougher finish on the work piece. Other chip breaker tools include a series of notches that provide similar benefits as the sinusoidal design but are easier to manufacture and, because a portion of the original cutting edge is retained, they tend to produce a smoother surface finish on the work piece. Regardless of their configuration, chip breaker features produce smaller chips, and these smaller chips are more easily removed from conventional milling machines that often utilize auger type clean out systems.

Chip breaker tools have several drawbacks that decrease their tool life. First, because a portion of the cutting edge has been removed, the interrupted cutting edge will wear out faster, thereby decreasing overall tool life. Second, because the cutting edge is interrupted by a series of non-cutting gaps (i.e., the notches), some portions of the work piece are missed and removed by the subsequent cutting edge or edges. Here, the subsequent edges or edges are subjected to additional load when they remove the missed material and may be chipped. This chipping also decreases tool life.

### SUMMARY

In accordance with the present disclosure, a chip breaker geometry is provided. The chip breaker geometry may be utilized in a variety of rotary cutting tools having cutting blades. In some examples, the chip breaker geometry may include a plurality of notches formed into radial relief surfaces of the blades at an angle relative to a tool axis, wherein the angle is sufficient to define a secondary cutting edge in each of the notches. The notches may be uniformly distributed along each of the blades, or the notches may be randomly distributed along the blades, or the notches may be both uniformly distributed and randomly distributed.

Also provided herein is a cutting tool having cutting blades and at least one chip breaker arranged on each of the blades. The chip breakers may each define a gap, and at least one of the gaps may include a secondary cutting edge that overlaps at least a portion the gap defined in the preceding cutting blade.

Also provided herein is an uninterrupted cutting edge for a rotary cutting tool. In these examples, the uninterrupted cutting edge may include at least one first notch arranged at an intersection between a leading face of the first blade and a radial relief surface of the first blade, and at least one second notch arranged at an intersection between a leading face of the second blade and a radial relief surface of the second blade, wherein the at least one second notch at least partially overlaps the first notch upon rotation of the rotary cutting tool.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a side view of an example rotary cutting tool that may incorporate the principles of the present disclosure.

FIG. 2 is an exploded side view of the rotary cutting tool of FIG. 1.

FIG. 3A is an exploded side view illustrating an exemplary off-setting of chip breaking features.

FIG. 3B is a representation of an example material removal operation of the rotary cutting tool of FIGS. 1-3A.

FIG. 4 is a side view of the rotary cutting tool of FIGS. 1-2 having a plurality of alternate chip breaking features.

FIG. 5 is an exploded side view of the rotary cutting tool of FIG. 4 illustrating an exemplary chip breaking feature when evaluated in a plane perpendicular to a centerline of the rotary cutting tool.

FIG. 6 is an exploded top view of the rotary cutting tool of FIG. 4 depicting example operation.

FIG. 7 illustrates an exemplary rotary cutting tool configured with an uninterrupted cutting edge, according to one or more embodiments of the present disclosure.

FIG. 8 illustrates an alternate exemplary rotary cutting tool configured with an uninterrupted cutting edge, according to one or more embodiments of the present disclosure.

### DETAILED DESCRIPTION

The present disclosure is related to rotary cutting tools and, more particularly, to rotary cutting tools with chip breaker features.

The embodiments described herein provide rotary cutting tools, such as end mills, with chip breaker features that eliminate voids along a periphery of the rotary cutting tool such that there is no excess material for subsequent cutting edges to remove.

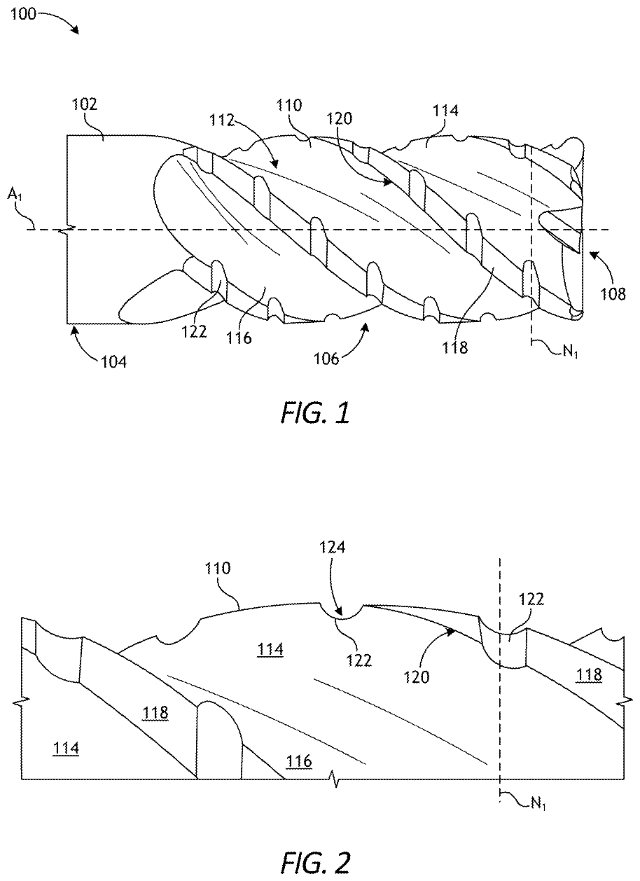

FIG. 1 is a side view of an example rotary cutting tool 100 (hereinafter, the “cutting tool 100”) that may be modified to incorporate the principles of the present disclosure. The depicted cutting tool 100 is just one example cutting tool that can suitably incorporate the principles of the present disclosure. Indeed, many alternative designs and configurations of the cutting tool 100 may be employed, without departing from the scope of this disclosure. For example, the principles of the present disclosure may be incorporated with various types of rotary cutting tools, such as end mills, drills, countersinks, counter bores, routers, etc. Thus, while the cutting tool 100 is illustrated and described as an end mill, it will nevertheless be appreciated that chip breaking features disclosed herein may be incorporated onto other types of rotary cutting tools without departing from the present disclosure. In the illustrated example, the cutting tool 100 is configured as an end mill having four (4) flutes may be used to mill a variety of materials including ferrous type work piece materials such as steel, stainless steel, titanium, etc. However, the cutting tool 100 may be differently configured with more or less flutes, for example, a multi-flute router, used for routing CFRP and plastic type materials.

As illustrated, the cutting tool 100 generally includes a cylindrical body 102 that extends longitudinally along an axis A₁ of the cylindrical body 102. Here, the cylindrical body 102 includes a shank portion 104 and a cutting portion 106 that generally defines the length of cut of the cutting tool 100, and the cutting portion 106 extends longitudinally along the axis A₁ to an axial face or axial end 108 of the cutting tool 100. The cutting portion 106 is illustrated as having a generally cylindrical shaped periphery, but it may be configured with various other geometries without departing from the present disclosure, including but not limited to a frusto-conical shape or ball nose shape.

The cutting portion 106 includes a plurality of blades 110 that are separated by a plurality of flutes 112. Each of the blades 110 has a leading face surface 114, a trailing face surface 116, and a radial relief surface 118 that bridges the leading face surface 114 and trailing face surface 116. As to each of the blades 110, a cutting edge 120 is formed at the intersection between the leading face surface 114 and the radial relief surface 118. Here, the blades 110 and flutes 112 extend along the cutting portion 106, helically about the axis A₁. The blades 110 may be oriented at various helix angles that are measured with respect to the axis A₁, and in other non-illustrated embodiments, the blades 110 and the flutes 112 may even be oriented parallel to the axis A₁. In operation, chips are removed from the work piece upward through the flutes 112 and towards the shank portion 104, and/or chips may be removed downward way from the shank portion 104 depending on cut direction of the cutting tool 100 (e.g., left-hand or right-hand helix).

The radial relief surface 118 may have various configurations. For example, the radial relief surface 118 may exhibit a generally cylindrical configuration, a generally planar configuration, a not-concave configuration, a faceted configuration, or an eccentric configuration when evaluated in cross section. Also, the radial relief surface 118 may include one or more relief surfaces that are oriented at one or more corresponding relief angles. For example, the radial relief surface 118 may include a primary relief surface disposed contiguous with the cutting edge 120 extending at a first relief angle relative to a tangential line drawn at the cutting edge 120. In other examples, the radial relief surface 118 may include a secondary relief surface that is disposed on a side of the primary relief surface opposite of the cutting edge 120 at a second relief angle relative to the previously mentioned tangential line, where the magnitude of the second relief angle is greater than the magnitude of the first relief angle. In even other examples, the radial relief surface 118 may include additional relief surfaces, such as a tertiary portion disposed on a side of the second relief surface that is opposite of the first relief surface. These relief surfaces may be provided linearly, or may extend arcuately to blend into each other and/or the trailing face surface 116.

The cutting tool 100 is configured as a chip breaker (i.e., a chip breaking end mill) and thus includes a plurality of chip breaking features 122 disposed along the cutting edges 120. Conventional cutting tools (i.e., without chip breaking features) have continuous cutting edges that remove long and continuous chips of material from work pieces. In contrast, the plurality of chip breaking features 122 arranged in the cutting edges 120 of the cutting tool 100 break each of those otherwise continuous chips of material into discrete chips of material. The chip breaking features 122 may be notches or recesses that are ground or otherwise formed into the radial relief surface 118.

The chip breaking features 122 are disposed in the radial relief surface 118, extending there-through along a notch axis N₁, and open into the leading face surface 114 at the cutting edge 120. As illustrated, the chip breaking features 122 on the cutting edge 120 of one of the blades 110 are offset longitudinally along the axis A₁ from the chip breaking features 122 on the other blades 110 (i.e., the notch axes N₁ of the chip breaking features 122 on one of the cutting edges 120 do not align with the notch axes N₁ of the chip breaking features 122 on another of the cutting edges 120). Thus, the chip breaking features 122 on any one of the blades 110 are not in alignment with the chip breaking features 122 of any other of the remaining blades 110 when the cutting tool 100 is rotated in direction R about the axis A₁.

During operation, the chip breaking features 122 generate a reduction in cutting force experienced in the blades 110 in which they are disposed, and thereby enhance performance. The cutting edges 120 remove material from the workpiece (i.e., in the form of chips) and such material is pushed out through the flutes 112. However, the chip breaking features 122 each define a gap or void 124 in the cutting edge 120 where material is not removed from the work piece, resulting in the cutting edge 120 removing smaller discrete chips that are then pushed through the flutes 112. As discussed below, however, these portions of workpiece material that are not cut (i.e., removed from the work piece) as they pass through the gaps or voids 124 in the cutting edge are later cut (i.e., removed from the work piece) by the cutting edges 120 of one or more of the other blades 110 as the cutting tool 100 continues to rotate.

FIG. 2 is an exploded side view of one of the cutting edges 120 of the cutting tool 100 of FIG. 1. As illustrated, the gaps or voids 124 function as channels or passageways formed into the cutting edge 120 and that permit work piece material to pass there-through without being cut by the cutting edge 120 that is engaging and cutting the work piece. Thus, the cutting edge 120 is interrupted by the gaps or voids 124 such that the cutting edge 120 is discontinuous and does not remove material at locations of the cutting edge 120 where the chip breaking features 122 have been formed. In addition, the gaps or voids 124 in the cutting edge 120 provide the cutting edge 120 with a varied geometry at the intersection of the leading face surface 114 and the radial relief surface 118. In this manner, the chip breaking features 122 disrupt the cutting edge 120 of the cutting tool 100, and the cutting edge 120 of the cutting tool 100 is said to be an interrupted or discontinuous cutting edge.

The chip breaking features 122 and the gaps or voids 124 defined thereby may have various geometries. In the illustrated example, all of the chip breaking features 122 (and, thus, the gaps or voids 124) have an arcuate shaped geometry. In other examples, the chip breaking features 122 (and the gaps or voids 124) may all be of a different geometry, for example, rectangular geometries, triangular geometries, and combinations of the same. In even other embodiments, the chip breaking features 122 (and the gaps or voids 124) of one of the blades 110 may have a different geometry from the chip breaking features 122 (and the gaps or voids 124) of the remaining of the blades 110. Moreover, in some example the chip breaking features 122 (and the gaps or voids 124) of one or more of the blades 110 have different geometries.

Various methods may be utilized to form the chip breaking features 122, regardless of their geometry. In one example, the chip breaking features 122 are ground into the radial relief surface 118.

The chip breaking features 122 (and the gaps or voids 124 that correspond therewith) may also have various orientations and pitches. In the example of FIGS. 1-2, the chip breaking features 122 are all oriented approximately perpendicular to the axis A₁ and at the same pitch. Thus, a notch angle evaluated between the axis A₁ and each of the notch axes N₁ is approximately 90°. As detailed below, however, orienting the chip breaking features 122 approximately perpendicular to the axis A₁ may result in an overloading of the cutting edges 120, especially at areas on the cutting edges 120 that are proximate to the gaps or voids 124. This increases the wear experienced in the cutting edges 120 as well as the likelihood of the cutting edges 120 becoming chipped, which thereby decreases overall tool life.

In these examples, the gaps or voids 124 in the cutting edges 120 leave excess material for subsequent cutting edges 120 to remove during a material removal operation. It is this excess material (i.e., the material that passed over by a first of the blades 110 and left to be removed by one or more subsequent blades 110) that causes the overload in the cutting edges 120. Thus, as the cutting tool 100 rotates in direction R about the axis A₁, the cutting edge 120 of a first of the blades 110 engages the work piece such that the cutting edge 120 removes material except at the chip breaking features 122, where remaining material pass through the gap or void 124; and the ensuing cutting edges 120 of the subsequent blades 110 each experience greater loads as they clean up and remove portions of that remaining material that was left by the gaps or voids 124 in the cutting edges 120 of the preceding blades 110. Thus, the cutting edges 120 may experience increased loading at areas proximate to the chip breaking features 122, which may result in decreased tool life.

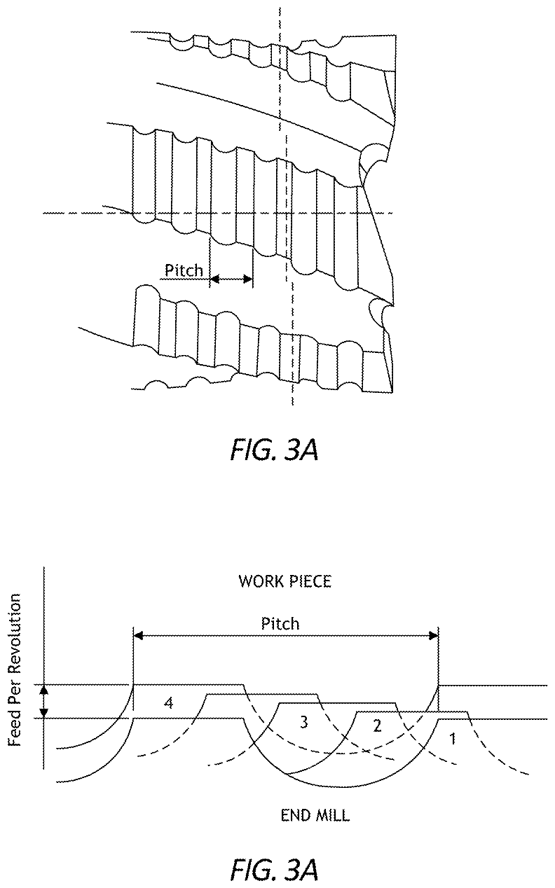

This increased loading (or overloading) of the cutting edges 120 at areas proximate the chip breaking features 122 is illustrated with respect to FIGS. 3A-3B. FIG. 3A illustrates an exemplary offsetting of the chip breaking features 122 around the periphery of the cutting tool 100 of FIGS. 1-2. As illustrated, the chip breaking features 122 on each of the cutting edges 120 are longitudinally offset (along the axis Ai) from the chip breaking features 122 on the other cutting edges 120, such the gaps or voids 124 in one of the cutting edges 120 do not fully align with the gaps or voids 124 on another of the cutting edges. While not being in complete alignment, the gaps or voids 124 of the different cutting edges 120 do partially align as illustrated in FIG. 3B, such that there is a continuous gap that extends between at least a pair of neighboring cutting edges 120 (i.e., the gaps or voids 124 in one of the cutting edges align with the gaps or voids 124 in at least another of the cutting edges). FIG. 3B illustrates four (4) interrupted cutting edges 1,2,3,4 that each include the chip breaking feature 122, where the chip breaking features 122 all have the same pitch but are off-set longitudinally along the axis A₁ relative to each other. As mentioned, the chip breaking features 122 are all off-set longitudinally along the axis A₁ relative to each other, meaning the gap or void 124 in the first interrupted cutting edge 1 does not align with the gap or void 124 in any of the subsequent interrupted cutting edges 2,3,4, the gap or void 124 in the second interrupted cutting edge 2 does not align with the gap or void 124 in any of the subsequent interrupted cutting edges 3,4, and the gap or void 124 in the third interrupted cutting edge 3 does not align with the gap or void 124 in the subsequent interrupted cutting edge 4. Thus, FIG. 3B illustrates how the chip breaking features 122 in the first interrupted cutting edge 1 leave material for the subsequent interrupted cutting edges 2,3,4 to remove as the subsequent interrupted cutting edges 2,3,4 are rotated into engagement with a work piece.

Here, for example, the first interrupted cutting edge 1 removes material from the work piece, except that the chip breaking feature 122 thereof does not remove material from the work piece. This material that passes through the gap or void 124 and is not removed from the work piece is referred to as “left over material.” As the second interrupted cutting edge 2 rotates into engagement with the workpiece, the second interrupted cutting edge 2 removes material from the work piece, including a portion of the left over material that was left by the chip breaking feature 122 of the first interrupted cutting edge 1, but the second interrupted cutting edge 2 also does not remove material at the location of its chip breaking feature 122. The chip breaking feature 122 in the second interrupted cutting edge 2 are longitudinally offset from chip breaking feature 122 in the first interrupted cutting edge 1 so that the second interrupted cutting edge 2 removes its normal amount of material plus only a portion of the left over material. Thus, some portions of the second cutting edge 2 are removing twice the amount of material because these portions of the second cutting edge 2 are removing some of the left over material that was not removed via the gaps or voids 124 in the first interrupted cutting edge 1. As the third interrupted cutting edge 3 rotates into engagement with the workpiece, the third interrupted cutting edge 3 removes material from the work piece, including a portion of the left over material that was left by the gaps or voids 124 in the first interrupted cutting edge 1 and the second interrupted cutting edge 2, but the third interrupted cutting edge 3 also does not remove material at the location of its gaps or voids 124 so that a portion of the left over material is remains for one or more subsequent cutting edges (e.g., the fourth interrupted cutting edge 4) to engage and remove (clean up). As previously mentioned, the chip breaking features 122 in the third interrupted cutting edge 3 are longitudinally offset from the chip breaking features 122 in the first and second interrupted cutting edges 1,2 so that the third interrupted cutting edge 3 removes its normal amount of material plus only a portion of the left over material. Thus, some portions of the third interrupted cutting edge 3 are removing triple the amount of material, as the third interrupted cutting edge 3 is also removing some of the left over material that passed through the gaps or voids 124 in the first and second interrupted cutting edges 1,2 and was not removed by the first and second interrupted cutting edges 1,2. As the fourth interrupted cutting edge 4 rotates into engagement with the workpiece, the fourth interrupted cutting edge 4 removes material from the work piece, including a portion of the left over material that was left by the gaps or voids 124 in the first, second, and third interrupted cutting edges 1,2,3. However, the fourth interrupted cutting edge 4 does not remove material at the location of its gaps or voids 124, which are longitudinally offset from chip breaking feature 122 in the first, second, and third interrupted cutting edges 1,2,4, thereby resulting in the fourth interrupted cutting edge 4 removing its normal amount of material plus the remaining portion of the left over material that was not cleaned up by the second or third interrupted cutting edges 2,3. Thus, some portions of the fourth interrupted cutting edge 4 are removing quadruple the amount of material, as the fourth interrupted cutting edge 4 is also removing portions of the left over material that was not removed by the chip breaking feature 122 of the first, second, and third interrupted cutting edges 1,2,3. Accordingly, areas of the various interrupted cutting edges 1,2,3,4 may encounter elevated loads that may exceed the programmed feed rate.

According to embodiments of the present disclosure, chip breaking features may be arranged nearly parallel to the axis A₁. In such embodiments, the chip breaking features each define a secondary cutting edge, and these secondary cutting edges eliminate any overlapping or alignment of the gaps or voids 124 between neighboring cutting edges 120 when the chip breaking features 122 are oriented approximately perpendicular to the axis A₁ as described with reference to FIGS. 1-3, above. Orienting the chip breaking features nearly parallel to the axis A₁ not only provides an interrupted cutting edge that effectively breaks otherwise continuous chips of material into discrete chips of material, but also thus defines secondary cutting edges that effectively eliminate the gaps or voids 124 (i.e., “gapless”) through which work piece material would otherwise pass and remain for a subsequent cutting edge. Accordingly, the secondary cutting edges remove material that would otherwise pass through the gaps or voids 124 so that little (if any) material is left for a subsequent cutting edge to clean up, which in turn lowers stress on the cutting edges and improves part finish and overall tool life. Because these secondary cutting edges eliminate the effect of the gaps or voids 124, chip breaker cutting tools having such secondary cutting edges are sometimes referred to as “gapless” cutting tools or “gapless chip breakers.”

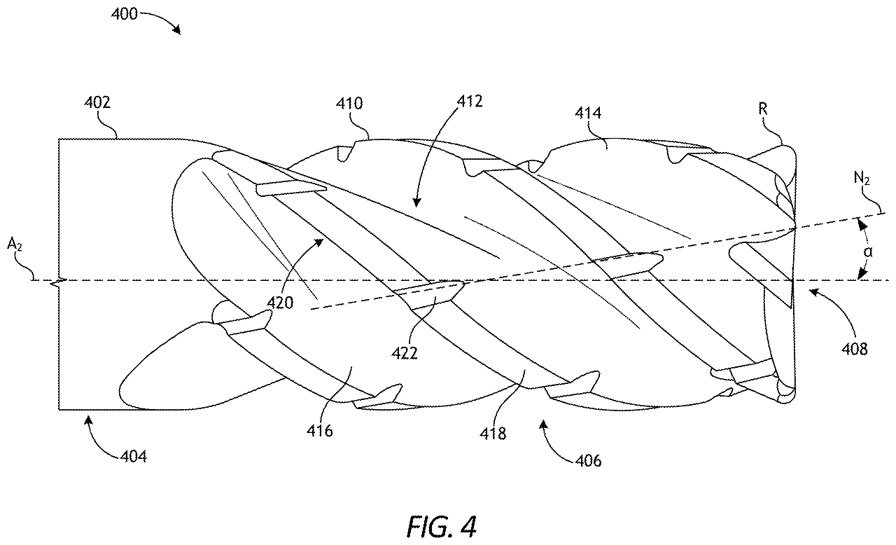

FIG. 4 is a side view of an example gapless chip breaker 400, according to one or more embodiments of the present disclosure. Here, the gapless chip breaker 400 is configured as an end mill; however, the depicted gapless chip breaker 400 is just one example cutting tool that may suitably incorporate the principles of the present disclosure. Indeed, many alternative designs and configurations of the gapless chip breaker 400 may be employed without departing from the scope of this disclosure. Thus, the principles of the present disclosure may be incorporated into various other rotary cutting tools (e.g., countersinks, routers, etc.) without departing from the present disclosure.

The gapless chip breaker 400 illustrated and described herein is similar to the cutting tool 100 of FIGS. 1-2. Thus, the gapless chip breaker 400 generally includes a cylindrical body 402 that extends longitudinally along an axis A₂ of the cylindrical body 402. The cylindrical body 402 includes a shank portion 404 and a cutting portion 406 that generally defines the length of cut of the gapless chip breaker 400, and the cutting portion 406 extends longitudinally along the axis A₂ to an axial face or axial end 408 of the gapless chip breaker 400. The cutting portion 406 is illustrated as having a generally cylindrical shaped periphery, but it may instead be configured with various other geometries without departing from the present disclosure. For example, the cutting portion 406 may taper inward or outward (relative to the axis A₂) towards the axial end 408, may be configured as a slot cutter, may be configured as a ball nose cutter, etc. Also, in some examples, the cutting portion 406 may transition into the axial end 408 at a corner radius R.

The cutting portion 406 includes a plurality of blades 410 that are separated by a plurality of flutes 412. Each of the blades 410 has a leading face surface 414, a trailing face surface 416, and a radial relief surface 418 that bridges the leading face surface 414 and trailing face surface 416. As to each of the blades 410, a cutting edge 420 is formed at the intersection between the leading face surface 414 and the radial relief surface 418. Here, the blades 410 and the flutes 412 extend along the cutting portion 406, helically about the axis A₂. The blades 410 and the flutes 412 may be oriented at various helix angles that are measured with respect to the axis A₂, and in other non-illustrated embodiments, the blades 410 and the flutes 412 may be oriented approximately parallel to the axis A₂. Also, in some examples, the corner radius R and/or the axial end 408 may be configured to make cuts and, in such embodiments, may include either or both of a radius cutting edge and/or an axial cutting edge, respectively. Where utilized, the cutting edge 420 may smoothly transition into the radius cutting edge, which may in turn smoothly transition into the axial cutting edge.

The radial relief surface 418 may have various configurations. In the illustrated example, the radial relief surface 418 exhibits a generally cylindrical configuration when evaluated in cross section. In other embodiments, the radial relief surface 418 may exhibit a generally planar configuration, a not-concave configuration, a faceted configuration, or an eccentric configuration when evaluated in cross section. Also, the radial relief surface 418 may include one or more relief surfaces that are oriented at one or more corresponding relief angles, as described above with reference to FIGS. 1-2.

The gapless chip breaker 400 also includes a plurality of chip breaking features 422 arranged in each of the cutting edges 420. As described herein, the chip breaking features 422 interrupt the cutting edges 420 (i.e., such that the cutting edges 420 discontinuous), which results in smaller, discrete chips rather than long continuous chips that would be formed by an uninterrupted or continuous cutting edge. The chip breaking features 422 may be ground or otherwise formed in the radial relief surface 418. Here, the chip breaking features 422 are uniformly distributed in each of the cutting edges 420, and the chip breaking features 422 of each cutting edge 420 are off set (along the axis A₂) relative to the chip breaking features 422 in the other cutting edges 420. Moreover, in embodiments where the cutting portion 406 includes either or both of the radius cutting edge and/or the axial cutting edge, the chip breaking features 422 may be similarly arranged within either or both of the radial cutting edge and/or the axial cutting edge.

The chip breaking features 422 may have various geometries. In the illustrated embodiment, the chip breaking features 422 are formed with an arcuately-shaped base. In other embodiments, however, the chip breaking features 422 may include a substantially rectangular geometry, a substantially triangular geometry, trapezoidal, etc. In addition, in some embodiments, the chip breaking features 422 in one or more cutting edges 420 may have various geometric configurations.

The chip breaking features 422 may also have various organizations or distributions in each of the cutting edges 420 and/or between two or more cutting edges 420. For example, the chip breaking features 422 may be non-uniformly distributed within each of the cutting edges 420, and/or may be non-uniformly distributed between adjacent cutting edges 420. Where utilized, the pattern of non-uniformly distributed chip-breaking features 422 may be such that the material being machined at any given position is not subject to a uniform pattern of chip breaking features 422 as the gapless chip breaker 400 rotates. As a result, the gapless chip breaker 400 is not subject to significant uniform periodic forces that may give rise to an undesirable harmonic response under acceptable operating conditions. The non-uniform organizations or distributions may be created by arrangements such as, but not limited to: 1) dissimilar spacing between the chip breaking features 422 within a particular cutting edge 420; 2) dissimilar spacing (of the chip breaking features 422) between adjacent cutting edges 420; 3) dissimilar types (of the chip breaking features 422) within a particular cutting edge 420; 4) dissimilar types (of the chip breaking features 422) in adjacent cutting edges 420; 5) dissimilar groupings of chip breaking features 422 within a particular cutting edge 420; 6) dissimilar groupings of chip breaking features 422 between adjacent chip breaking features 422; or combinations thereof, etc.

The chip breaking features 422 are notches that extend through the radial relief surface 418 along a notch axis N₂, between the leading face surface 414 and the trailing face surface 416. Thus, the chip breaking features 422 are each oriented at a notch angle α, where the notch angle α is evaluated between the notch axis N₂ and the axis A₂. As further described below, a secondary cutting edge 424 may be defined in the chip breaking features 422 that are oriented with notch angles α that are less than 90°.

In the illustrated embodiment, all of the chip breaking features 422 are oriented at the same notch angle α. In other embodiments, however, the chip breaking features 422 need not all be oriented at the same notch angle α. For example, the chip breaking features 422 on one or more of the cutting edges 420 may be oriented at a different notch angle α than the chip breaking features 422 on one or more of the remaining cutting edges 420. In these or other examples, at least one of the chip breaking features 422 (or at least one group of chip breaking features 422) on one of the cutting edges 420 may have a different notch angle α than the other chip breaking features 422 (or other groups of chip breaking features 422) on that cutting edge 420.

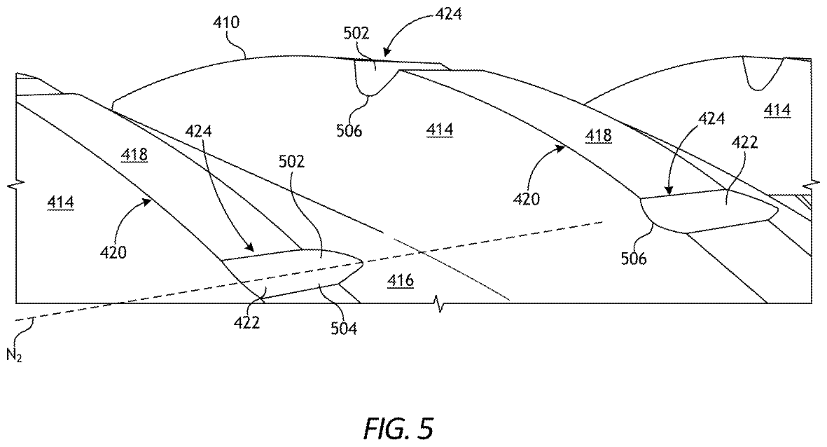

FIG. 5 is an exploded side view of the periphery of the gapless chip breaker 400 of FIG. 4, and further illustrates the chip breaking features 422 arranged within the cutting edges 420. As illustrated in FIGS. 4-5, the chip breaking features 422 each include a leading notch surface 502, a trailing notch surface 504, and a trough 506 that is formed at the intersection between the leading notch surface 502 and the trailing notch surface 504. Also, as illustrated in FIGS. 4-5, each of the secondary cutting surfaces 424 is formed at the intersection between the leading notch surface 502 and the radial relief surface 418.

By orienting the chip breaking features 422 with the notch angle α that defines the secondary cutting edge 424, the secondary cutting edge 424 on the radial relief 418 may eliminate any gap or void that may exist between the chip breaking features 422 in adjacent cutting edges 420. Thus, the secondary cutting edges 424 of one of the blades 410 may remove or clean up any left over material that was not removed by the cutting edge 420 (e.g., via the chip breaking features 422 thereof) of that same blade 410. This will lower the loading on the adjacent blades 410 as they will not need to remove and clean up as much material (for example, the adjacent blades 410 will clean up a remaining small amount of material that is equivalent to the radial relief), which in turn improves tool life and part finish.

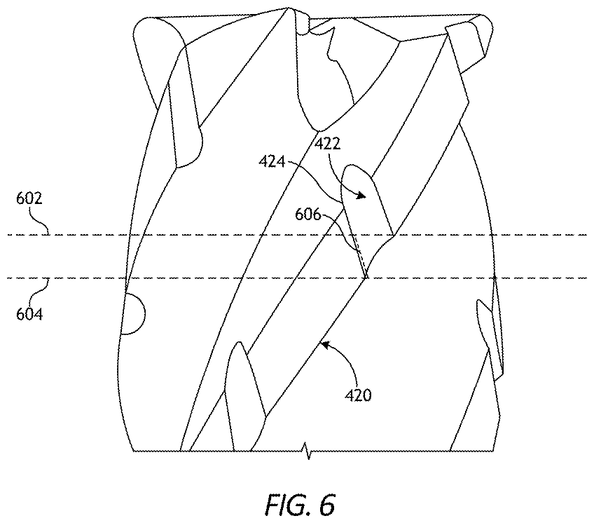

FIG. 6 illustrates an exploded top view of the axial end 408 of the gapless chip breaker 400 of FIG. 4. More specifically, FIG. 6 illustrates how repositioning the chip breaking features 422 into a non-perpendicular orientation may eliminate the gaps or voids in the cutting edge 420. As described with reference to FIGS. 1-3, the chip breaking features 122 oriented in a perpendicular orientation create gaps or voids 124, which are represented by a pair of dashed lines 602,604. Thus, the space between the dashed lines 602,604 represents the gaps or voids 124 passing through the cutting edge 120 where material is missed (not removed) and left for subsequent cutting edges 120 to clean up. However, angling the chip breaking features 422 will form the secondary cutting edges 424 to remove material (and form chips thereof) that would otherwise pass through the gaps or voids 124 represented by the dashed lines 602,604. As illustrated in FIG. 6, at least a portion 606 of the secondary cutting edge 424 will be presented to the work piece during rotation so as to remove material missed by the cutting edge 420 at the location of the chip breaking feature 422. Accordingly, the portion 606 of the secondary cutting edge 424 eliminates or closes any gaps or voids and produces a chip in an area where no chip would otherwise be produced.

The chip breaking features 424 may be oriented at various angles. As mentioned, the notch angle α of each of the chip breaking features 422 is sufficient for providing the secondary cutting edge 424. The notch angle α may be selected such that the secondary cutting edge 424 closes the gaps or voids in the cutting edge 420 that would otherwise permit left over material to remain for subsequent cutting edges 420 to clean up. Thus, as illustrated in FIG. 5, where the chip breaking features 422 define gaps in the cutting edge 420, the notch angle α may be selected such that the secondary cutting edge 424 is at least equal to a projection of the gaps projected within the chip breaking features 422 when evaluated in a plane that is perpendicular to the axis A₂; and, as described with reference to FIG. 6, where the chip breaking features 422 define openings in the leading face surface 414 of the blades 410, the notch angle α may be selected such that the secondary cutting edge 424 is at least equal to a projection of openings projected within the chip breaking features 422 when evaluated in a plane that is perpendicular to the axis A₂.

In some of these examples, the notch angle α is selected such that less than the entire length of the secondary cutting edge 424 closes the gaps or voids in the cutting edge 420 that would otherwise permit left over material to remain for subsequent cutting edges 420 to clean up (e.g., the portion 606 of the secondary cutting edge 424 as illustrated in FIG. 6). Stated differently, the notch angle α may be selected such that the secondary cutting edge 424 is greater than a projection of the gap or the opening projected within the chip breaking features 422 when evaluated in a plane that is perpendicular to the axis A₂. And, in even some of these examples, the chip breaking features 422 may be oriented such that their notch axes N₂ are approximately parallel to the axis A₂ of the gapless chip breaker 400. Thus, the notch angle α may be less than 90° and greater than or equal to 0° (90°>α≥0°).

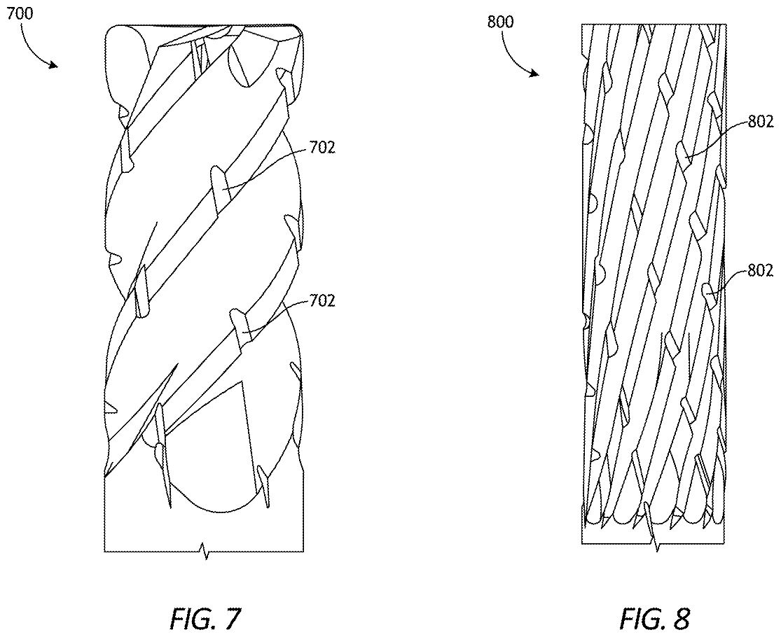

The chip breaking feature designs disclosed herein may various configurations depending on the tool upon which they are provided. FIG. 7 illustrates an example 4-flute end mill 700 configured with chip breaking features 702, according to one or more embodiments of the present disclosure. The 4-flute end mill 700 may be used for milling a variety of ferrous type work piece materials, such as steel, stainless steel, titanium, etc. As described above, the chip breaking features 702 define a gapless cutting edge as the tool rotates against a work piece and, therefore, the 4-flute end mill 700 incorporates a gapless chip breaker design. FIG. 8 illustrates an example multi-flute router 800 having chip breaking features 802, according to one or more embodiments of the present disclosure. The multi-flute router 800 may be utilized in a variety of applications, for example, routing CFRP and plastic type materials. As described above, the chip breaking features 802 define a gapless cutting edge as the tool rotates against a work piece and, therefore, the multi-flute router 800 also incorporates a gapless chip breaker design. While both the 4-flute end mill 700 and the multi-flute router 800 incorporate a gapless chip breaker design, the specific parameters of the chip breaking features (for example, width, pitch, etc.) are not the same in this example (and need not be the same in other examples) due to the differences in the tool design of the 4-flute end mill 700 and the multi-flute router 800. Thus, various parameters (e.g., width, pitch, right-hand cutting helix, left-hand cutting helix, etc.) of the chip breaking features may be utilized and still provide a “gapless” design. Not only may the parameters of the chip breaking features vary between different types of cutting tools, but they may also vary with the same type of tool.

Thus, a certain end mill may be configured with a first set of chip breaking features to provide it with a “gapless” design or instead be configured with various other sets of chip breaking features that also provide it with a “gapless” design. In some examples, any combination of right-hand and left-hand helix and chip breaker width, and radial relief angle that eliminates the normally open area in the cutting edge would create a gapless chip breaker. In these examples, the primary radial relief may be eccentric or flat (e.g., not concave) and may be of enough width to cover the gap.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A chip breaker geometry for a cutting tool, wherein the cutting tool includes a cutting portion that extends along a tool axis to an axial end, a plurality of blades extending along a length of the cutting portion and radially outward from the tool axis, and a cutting edge formed on each of the blades at an intersection between a leading face of the blade and a radial relief surface of the blade, the chip breaking geometry comprising:
a plurality of notches formed into the radial relief surfaces at an angle relative to the tool axis, wherein the angle is sufficient to define a secondary cutting edge in each of the notches.

2. The chip breaker geometry of claim 1, wherein the notches define gaps in the cutting edges, and the secondary cutting edge is greater than or equal to a projection of the gap formed within the notch when evaluated in a plane that is perpendicular to the tool axis.

3. The chip breaker geometry of claim 1, wherein the notches are passageways having openings in the leading faces of the blades, and the secondary cutting edges are all greater than or equal to projections of the openings within the passageways when evaluated in a plane that is perpendicular to the tool axis.

4. The chip breaker geometry of claim 1, wherein the secondary cutting edge is formed at an intersection between a leading surface of the notch and the radial relief surface

5. The chip breaker geometry of claim 1, wherein the angle is sufficient such that, as a first of the notches on a first of the cutting edges rotates around an axis of the cutting tool to define a gap a radial orientation, at least a portion of a second of the notches on a second of the cutting edges overlaps the gap when the second cutting edge rotates into the radial orientation.

6. The chip breaker geometry of claim 1, wherein the notches include a geometrical configuration selected from the group consisting of arcuate, rectangular, triangular, and trapezoidal, and combinations of the same.

7. The chip breaker geometry of claim 1, wherein the notches are ground into the radial relief surfaces.

8. The chip breaker geometry of claim 1, wherein the notches are uniformly or randomly distributed within each of the radial relief surfaces.

9. The chip breaker geometry of claim 8, further comprising a plurality of second notches formed into the radial relief surfaces at a second angle relative to the tool axis, wherein the second angle is sufficient to define a second secondary cutting edge in each of the second notches, and wherein the second angle is different than the angle.

10. The chip breaker geometry of claim 9, wherein the second notches include a geometrical configuration selected from the group consisting of arcuate, rectangular, triangular, and trapezoidal, and combinations of the same.

11. The chip breaker geometry of claim 9, wherein each of the second secondary cutting edges are formed at an intersection between a leading surface of the second notch and the radial relief surface.

12. The chip breaker geometry of claim 9, wherein the second notches each define second gaps in the cutting edges, and each of the second secondary cutting edges is greater than or equal to a projection of the second gap formed within the second notch when evaluated in a plane that is perpendicular to the tool axis.

13. The chip breaker geometry of claim 9, wherein the second notches are second passageways having second openings in the leading faces of the blades, and the secondary cutting edges are all greater than or equal to projections of the second openings within the second passageways when evaluated in a plane that is perpendicular to the tool axis.

14. A cutting tool, comprising:
a tool body oriented along an axis;
at least two blades extending radially outward from a longitudinal axis along at least a portion of the tool body, the at least two blades include a first blade and a second blade that rotates into a position formerly occupied by the first blade upon rotation of the tool body about the longitudinal axis, wherein each blade includes a cutting edge formed at an intersection between a leading face of the blade and a radial relief surface of the blade,
at least one first chip breaker arranged on the first blade to define at least one first gap in the first cutting edge and at least one second chip breaker arranged on the second blade to define at least one second gap in the second cutting edge, wherein the at least one second gap includes a secondary cutting edge that overlaps at least a portion of the at least one first gap defined by the first chip breaker when the second blade rotates into the position formerly occupied by the first blade.

15. The cutting tool of claim 14, wherein the second chip breaker is oriented at an angle relative to the longitudinal axis sufficient to define the secondary cutting edge.

16. The cutting tool of claim 14, wherein the chip breakers are ground into the radial relief surface.

17. The cutting tool of claim 14, wherein the gaps are uniformly or randomly distributed within each of the radial relief surfaces.

18. An uninterrupted cutting edge for a rotary cutting tool, the rotary cutting tool having a body oriented along an axis, at least two blades extending along a cutting length of the body, radially outward from the axis, and a cutting edge formed on each of the blades at an intersection between a leading face of the blade and a radial relief surface of the blade, the uninterrupted cutting edge comprising:
at least one first notch arranged at an intersection between a leading face of the first blade and a radial relief surface of the first blade; and
at least one second notch arranged at an intersection between a leading face of the second blade and a radial relief surface of the second blade, wherein the at least one second notch at least partially overlaps the first notch upon rotation of the rotary cutting tool.

19. The uninterrupted cutting edge of claim 18, wherein the at least one second notch defines a secondary cutting edge.

20. The uninterrupted cutting edge of claim 19, wherein at least a portion of the secondary cutting edge overlaps the first notch.

21. The uninterrupted cutting edge of claim 19, wherein the at least one second notch is an at least one primary second notch, and the uninterrupted cutting edge further comprises:
further comprising at least one secondary second notch arranged at the intersection between the leading face of the second blade and the radial relief surface of the second blade, wherein the at least one secondary second notch at least partially overlaps the first notch upon rotation of the rotary cutting tool, and wherein the at least one secondary second notch and the at least one primary second notch are differently oriented relative to the axis.

22. The uninterrupted cutting edge of claim 18, wherein the at least one first notch defines a secondary cutting edge.

23. The uninterrupted cutting edge of claim 22, wherein at least a portion of the secondary cutting edge of the first notch overlaps at least one of the second notches.

24. The uninterrupted cutting edge of claim 22, wherein the at least one first notch is an at least one primary first notch, and the uninterrupted cutting edge further comprises:
at least one secondary first notch arranged at the intersection between the leading face of the first blade and the radial relief surface of the first blade, wherein the at least one secondary first notch at least partially overlaps the primary first notch upon rotation of the rotary cutting tool, and wherein the at least one secondary first notch and the at least one primary first notch are differently oriented relative to the axis.
